(19) United States
(12) Patent Application Publication
(10) Pub. No.: US 2011/0149794 A1
(43) Pub. Date: Jun. 23, 2011

(54) APPARATUS AND METHOD FOR DYNAMICALLY SAMPLING OF FLOW

(75) Inventors: Sang Wan KIM, Seoul (KR); Sang Sik Yoon, Gwangju (KR); Dong Won Kang, Daejeon (KR); Sang Kil Park, Daejeon (KR); Joon Kyung Lee, Daejeon (KR)

(73) Assignee: Electronics and Telecommunications Research Institute, Daejeon (KR)

(21) Appl. No.: 12/973,451

(22) Filed: Dec. 20, 2010

(30) Foreign Application Priority Data
Dec. 21, 2009 (KR) 10-2009-0127991

(51) Int. Cl. H04L 12/26

(52) U.S. Cl. 370/253

(57) ABSTRACT

Provided are a dynamic flow sampling apparatus and dynamic flow sampling method. According to embodiments of the present invention, by collecting load information about a load of an Internet network and dynamically performing a flow sampling with respect to a packet based on the load information and a reference value, the load on an Internet network device and a data processing time for a traffic analysis may be reduced. Further, since an amount of traffic in a population to be analyzed may increase, reliability on an analysis result may be enhanced.

### CROSS-REFERENCE TO RELATED APPLICATION

This application claims the benefit of Korean Patent Application No. 10-2009-0127991, filed on Dec. 21, 2009, in the Korean Intellectual Property Office, the disclosure of which is incorporated herein by reference.

### BACKGROUND

1. Field of the Invention

The present invention relates to an apparatus and method for dynamically sampling of flow.

2. Description of the Related Art

A scheme for collecting and analyzing traffic of an Internet network may be used for various purposes such as a configuration, management, charge, control, and the like with respect to the Internet network.

When all traffic on the Internet network is measured, the traffic may be accurately analyzed. However, since an Internet network is recently becoming faster, collecting all the traffic may cause an increased load of a device with respect to the Internet network. As an amount of the collected traffic becomes larger, a data processing time for analysis may become longer, and a huge storage space may be used for storing the collected traffic. When all data are processed on a high-speed line of the Internet network, costs for collecting and analyzing the traffic may rapidly increase.

Accordingly, a scheme for sampling the traffic of the Internet network to collect and analyze the traffic has been developed. As the scheme for sampling the traffic, a static sampling scheme that samples the traffic based on a time period or the input packet number, and the like, may be given.

However, in a case of collecting and analyzing the traffic based on the static sampling scheme, due to a simple sampling scheme, an amount of traffic in a sampled population to be analyzed may be limited.

Accordingly, a new scheme for collecting and analyzing the traffic in the Internet network is desired.

### SUMMARY

An aspect of the present invention provides a dynamic flow sampling apparatus, including a traffic receiver to receive traffic, a system monitoring unit to collect load information about a load of an Internet network, a storage unit to store a reference value with respect to a flow sampling, a flow sampling processor to perform the flow sampling with respect to a packet included in the traffic, based on the load information and the reference value, and a traffic transmitter to transmit the traffic with respect to the flow-sampled packet.

Another aspect of the present invention also provides a dynamic flow sampling method, including receiving traffic, collecting load information about a load of an Internet network, performing the flow sampling with respect to a packet included in the traffic, based on the load information and the reference value, and transmitting the traffic with respect to the flow-sampled packet.

According to an aspect of the present invention, by collecting load information about a load of an Internet network and dynamically performing a flow sampling with respect to a packet based on the load information and a reference value, a load on an Internet network device and a data processing time for a traffic analysis may be reduced.

According to an aspect of the present invention, since an amount of traffic in a population to be analyzed may increase, reliability on an analysis result may be enhanced.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a dynamic flow sampling apparatus according to an embodiment of the present invention;

FIG. 2 is a diagram illustrating a flow sampling processor performing a flow sampling according to an embodiment of the present invention;

FIG. 3 is a diagram illustrating a flow sampling processor performing a flow sampling according to another embodiment of the present invention;

FIG. 4 is a diagram illustrating a flow sampling processor performing a flow sampling according to still another embodiment of the present invention; and

FIG. 5 is a diagram illustrating a dynamic flow sampling scheme according to an embodiment of the present invention;

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

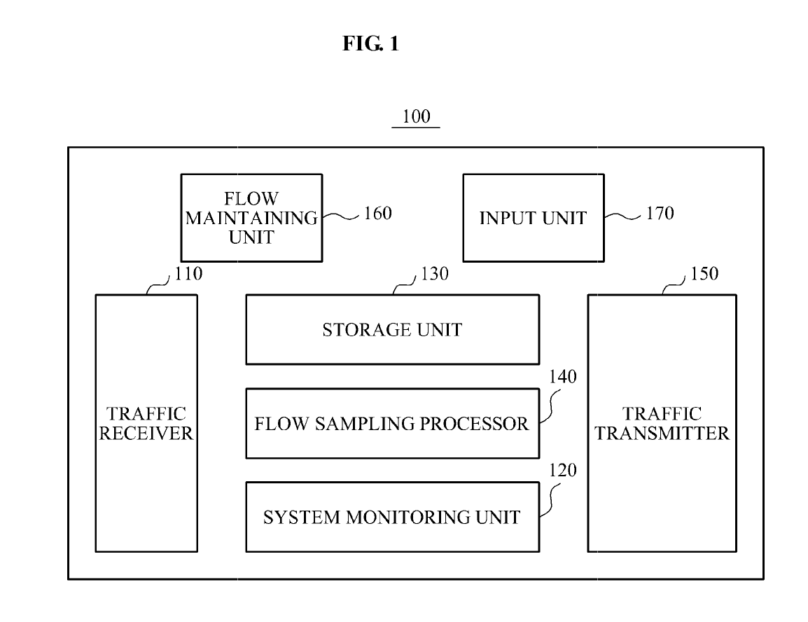

FIG. 1 is a diagram illustrating a configuration of a dynamic flow sampling apparatus 100 according to an embodiment of the present invention.

Referring to FIG. 1, the dynamic flow sampling apparatus 100 may include a traffic receiver 110, a system monitoring unit 120, a storage unit 130, a flow sampling processor 140, and a traffic transmitter 150.

The traffic receiver 110 may receive traffic of an Internet network. Depending on embodiments, the dynamic flow sampling apparatus 100 may be configured as a separate apparatus, and may be connected to an Internet network such as a traffic splitter, and the like to receive the traffic from an apparatus for copying the traffic. The dynamic flow sampling apparatus 100 may be inserted into network equipment of the Internet network such as a router, and the like in a module form to receive the traffic.

The system monitoring unit 120 may collect load information about a load of the Internet network.

The load information may include information about at least one of a current number of flows in contrast to a maximum number of the flows to be maintained by the Internet network, and a number of the packets included in the flows. Depending on embodiments, the load information may include information about a load of a flow maintaining unit 160.

The storage unit 130 may store a reference value with respect to a flow sampling.

The flow may be a set of packets having the same characteristic among Internet network packets. The flow sampling may correspond to a scheme for sampling packets using a predetermined operation rule focusing on the flow.

The reference value may correspond to a reference value with respect to a parameter associated with the Internet network. For example, the reference value may correspond to a value with respect to one of a number of flows maintained by the Internet network, a number of the packets included in the flows, and a size of the packet.

According to an embodiment of the present invention, the dynamic flow sampling apparatus 100 may further include an input unit 170. The input unit may receive the reference value from a user of the Internet network. Depending on embodiments, the storage unit 130 may store the reference value received from the input unit 170.

The flow sampling processor 140 may perform the flow sampling with respect to the packet included in the traffic received by the traffic receiver 110, based on the load information collected in the system monitoring unit 120 and the reference value stored in the storage unit 130.

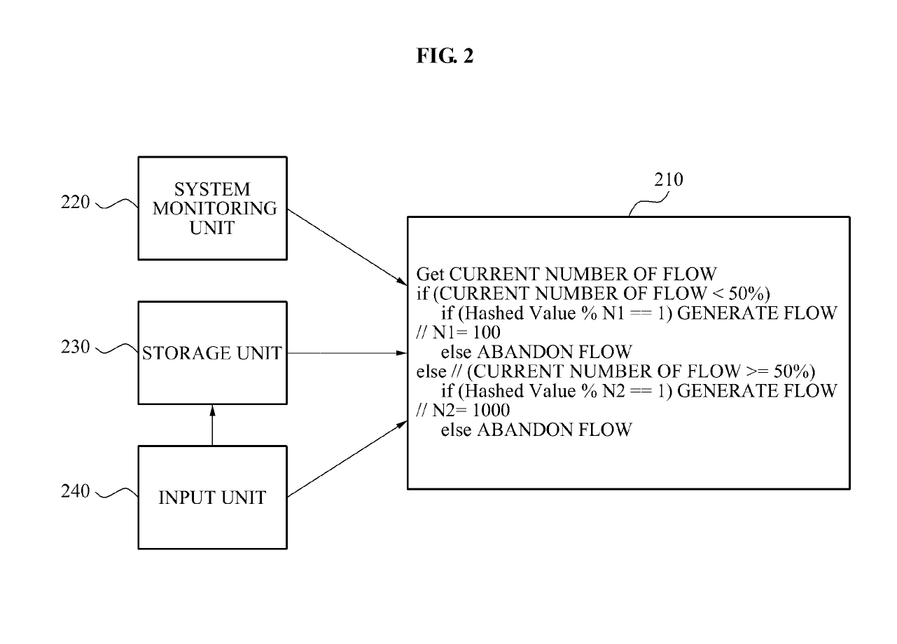

According to an embodiment of the present invention, the flow sampling processor 140 may correct the load information and information about at least one of a sampling cycle count and a sampling random probability included in the packet included in the traffic received by the traffic receiver 110. The flow sampling processor 140 may perform the flow sampling with respect to the packet in response to the corrected information. An embodiment of performing the flow sampling by the flow sampling processor 140 will be further described with reference to FIG. 2 to FIG. 4.

According to an embodiment of the present invention, the input unit 170 may receive sampling information about a scheme of performing the flow sampling. The flow sampling processor 140 may perform the flow sampling with respect to the packet in response to the sampling information received by the input unit 170.

The traffic transmitter 150 may transmit the traffic with respect to the flow-sampled packet.

According to an embodiment of the present invention, the dynamic flow sampling apparatus 100 may further include a flow maintaining unit 160. The flow maintaining unit 160 may maintain the flow-sampled packet for each flow.

FIG. 2 is a diagram illustrating a flow sampling processor 210 performing a flow sampling according to an embodiment of the present invention.

Referring to FIG. 2, the flow sampling processor 210 may receive, from a system monitoring unit 220, load information about a number of flows currently maintained by an Internet network.

The flow sampling processor 210 may receive a stored reference value from a storage unit 230. The reference value may be 50% corresponding to a reference value with respect to a rate (percentage) of the number of flows currently maintained by the Internet network in contrast to a maximum number of the flows to be maintained by the Internet network. Depending on embodiments, the storage unit 230 may receive, from an input unit 240, and store the 50% corresponding to the reference value, and may transmit the stored reference value that is 50% to the flow sampling processor 210.

According to an embodiment of the present invention, the flow sampling processor 210 may directly receive the reference value that is 50% from the input unit 240 receiving the reference value from a user of the Internet network.

The flow sampling processor 210 may perform the flow sampling with respect to the packet included in the flow received by a dynamic flow sampling apparatus, based on load information, that is, the number of flows currently maintained by the Internet network, received from the system monitoring unit 220 and the reference value that is 50% received from the storage unit 230 or the input unit 240.

Depending on embodiments, when the number of flows currently maintained by the Internet network is less than 50% of the maximum number of flows to be maintained by the Internet network, the flow sampling processor 210 may generate the flows with a cycle count N set to be 100 with respect to newly generated flows. When the number of flows currently maintained by the Internet network is greater than or equal to 50% of the maximum number of flows to be maintained by the Internet network, the flow sampling processor 210 may generate the flows with the cycle count N set to be 1000 with respect to the newly generated flows.

An operation of performing the flow sampling by the flow sampling processor 210 may be shown as, for example, Table 1 below.

TABLE 1

Get a current number of flows // provide associated information by

the system monitoring unit

if (the current number of flows < 50%)

if (Hashed Value % N1 == 1) generate flows // N1= 100
else abandon flows

else // (the current number of flows >= 50%)

if (Hashed Value % N2 == 1) generate flows // N2= 1000
else abandon flows

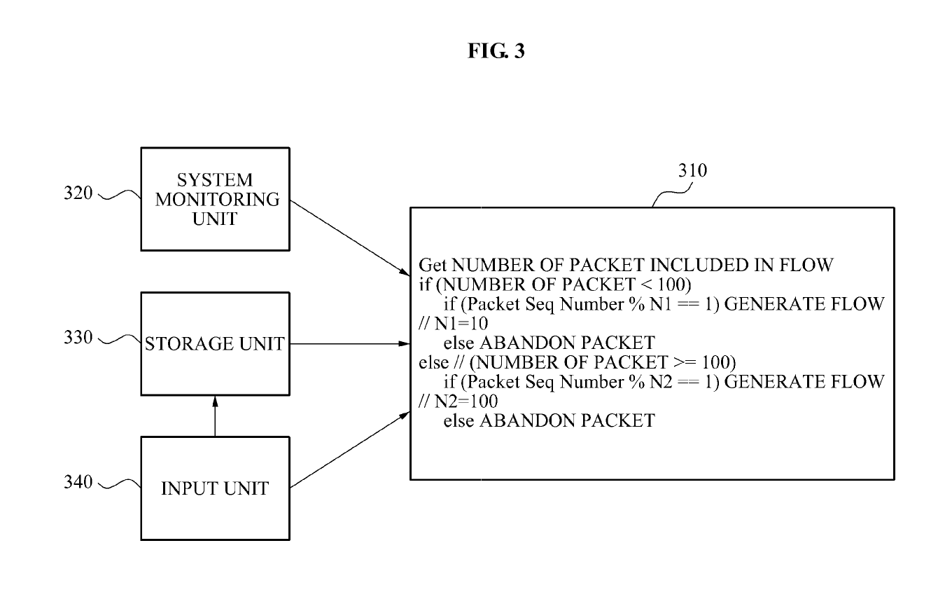

FIG. 3 is a diagram illustrating a flow sampling processor 310 performing a flow sampling according to another embodiment of the present invention.

Referring to FIG. 3, the flow sampling processor 310 may receive, from a system monitoring unit 320, load information about a number of packets included in a flow.

The flow sampling processor 310 may receive a stored reference value from a storage unit 330. The reference value may be 100 corresponding to a reference value with respect to the number of packets included in the flow. Depending on embodiments, the storage unit 330 may receive, from the input unit 340, and store the reference value that is 100, and may transmit the stored reference value of 100 to the flow sampling processor 310.

According to an embodiment of the present invention, the flow sampling processor 310 may directly receive the reference value of 100 from the input unit 340 receiving the reference value from a user of an Internet network.

The flow sampling processor 310 may perform the flow sampling with respect to the packet included in the traffic received by a dynamic sampling apparatus, based on the load information, that is, the number of the packets included in the flow, received from the system monitoring unit 320, and the reference value of 100 received from the storage unit 330 or the input unit 340.

Depending on embodiments, when the number of packets included in the flow is less than 100, the flow sampling processor 310 may perform the flow sampling with a cycle count N set to be 10 with respect to the packets included in the flow. When the number of packets included in the flow is greater than or equal to 100, the flow sampling processor 310 may perform the flow sampling with the cycle count N set to be 100 with respect to the packets included in the flow.

An operation of performing the flow sampling by the flow sampling processor 310 may be shown as, for example, Table 2 below.

TABLE 2

Get Flow Information // provide associated information by

the system monitoring unit

if (a number of packets of the flow < 100)

if (Packet Seq Number % N1 == 1) generate the flow // N1=10
else abandon the packet // increase Packet Seq Number and do

not update other flow information

else // (the number of packets of the flow >= 100)

if (Packet Seq Number % N2 == 1) generate the flow // N2=100
else abandon the packet

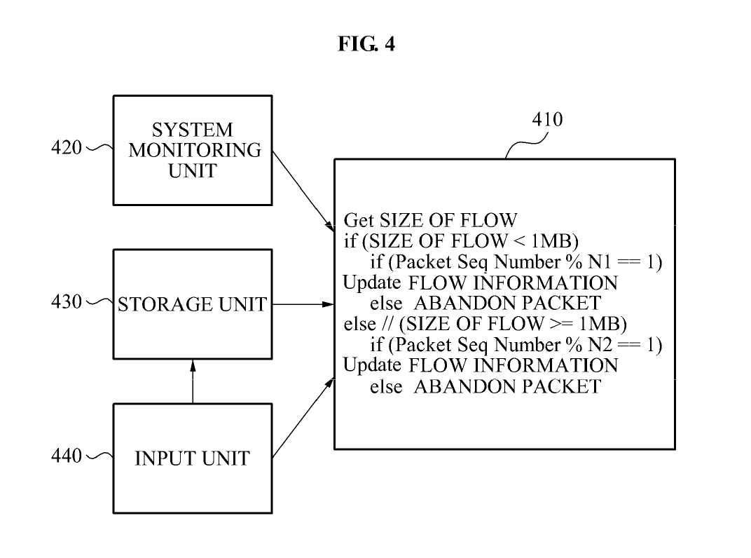

FIG. 4 is a diagram illustrating a flow sampling processor 410 performing a flow sampling according to still another embodiment of the present invention.

Referring to FIG. 4, the flow sampling processor 410 may receive, from a system monitoring unit 420, load information about a size of a flow.

The flow sampling processor 410 may receive a stored reference value from a storage unit 430. The reference value may be 1 Megabyte (MB) corresponding to the reference value with respect to the size of the flow. Depending on embodiments, the storage unit 430 may receive, from an input unit 440, and store 1 MB corresponding to the reference value, and may transmit the stored reference value 1 MB to the flow sampling processor 410.

According to an embodiment of the present invention, the flow sampling processor 410 may directly receive the reference value 1 MB from the input unit 440 receiving the reference value from a user of an Internet network.

The flow sampling processor 410 may perform the flow sampling with respect to the packet included in the flow received by a dynamic flow sampling apparatus, based on load information that is a size of the flow, received from the system monitoring unit 420, and the reference value that is 1 MB received from the storage unit 430 or the input unit 440.

Depending on embodiments, when the size of the flow is less than 1 MB, the flow sampling processor 410 may generate the flows with a cycle count N set to be 1000 with respect to the packet included in the flow. When the size of the flow is greater than or equal to 1 MB, the flow sampling processor 410 may perform the flow sampling with cycle count N set to be 10000 with respect to the packet included in the flow.

An operation of performing the flow sampling by the flow sampling processor 410 may be shown as, for example, Table 3 below.

TABLE 3

Get Flow Information
if (a byte size of the flow < 1MB)

if (Packet Seq Number % N1 == 1) Update flow information
else packet

else // (a byte size of the flow >= 1MB)

if (Packet Seq Number % N2 == 1) Update flow information
else abandon packet

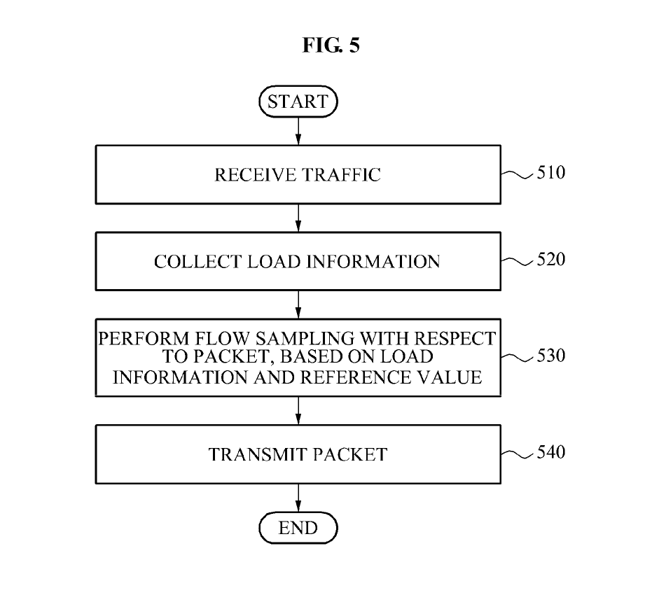

FIG. 5 is a diagram illustrating a dynamic flow sampling scheme according to an embodiment of the present invention.

Referring to FIG. 5, in operation 510, traffic of an Internet network may be received.

In operation 520, load information about a load of the Internet network may be collected.

The load information may include information about at least one of a current number of flows in contrast to a maximum number of the flows to be maintained by the Internet network, and a number of the packets included in the flows.

In operation 530, a flow sampling may be performed with respect to a packet included in the received traffic, based on load information and a stored reference value with respect to the flow sampling.

The reference value may correspond to a reference value with respect to a parameter associated with the Internet network. For example, the reference value may correspond to a value with respect to one of a number of flows maintained by the Internet network, a number of the packets included in the flows, and a size of the packet.

According to an embodiment of the present invention, the dynamic flow sampling scheme may further include receiving the reference value. Depending on embodiments, the dynamic flow sampling scheme may further include storing the received reference value.

According to an embodiment of the present invention, performing the flow sampling may include correcting information about at least one of a sampling cycle count and a sampling random probability included in the packet, and performing the flow sampling with respect to the packet in response to the corrected information.

According to an embodiment of the present invention, the dynamic flow sampling scheme may further include receiving sampling information about a scheme of performing the flow sampling. The flow sampling may be performed with respect to the packet in response to the received sampling information.

In operation 540, the traffic with respect to the flow-sampled packet may be transmitted.

According to an embodiment of the present invention, the dynamic flow sampling scheme may further include maintaining the flow-sampled packet for each flow.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A dynamic flow sampling apparatus, comprising:
a traffic receiver to receive traffic;
a system monitoring unit to collect load information about a load of an Internet network;
a storage unit to store a reference value with respect to a flow sampling;
a flow sampling processor to perform the flow sampling with respect to a packet included in the traffic, based on the load information and the reference value; and
a traffic transmitter to transmit the traffic with respect to the flow-sampled packet.

2. The apparatus of claim 1, further comprising:
a flow maintaining unit to maintain the flow-sampled packet for each flow.

3. The apparatus of claim 1, wherein the reference value corresponds to a value with respect to one of a number of flows maintained by the Internet network, a number of the packets included in the flows, and a size of the packet.

4. The apparatus of claim 1, wherein the flow sampling processor corrects information about at least one of a sampling cycle count and a sampling random probability included in the packet, and performs the flow sampling with respect to the packet in response to the corrected information.

5. The apparatus of claim 1, wherein the load information corresponds to information about at least one of a current number of flows in contrast to a maximum number of the flows to be maintained by the Internet network, and a number of the packets included in the flows.

6. The apparatus of claim 1, further comprising:
an input unit to receive the reference value.

7. The apparatus of claim 6, wherein:
the input unit receives sampling information about a scheme of performing the flow sampling, and
the flow sampling processor performs the flow sampling with respect to the packet in response to the sampling information.

8. A dynamic flow sampling method, comprising:
receiving traffic;
collecting load information about a load of an Internet network;
performing the flow sampling with respect to a packet included in the traffic, based on the load information and a reference value; and
transmitting the traffic with respect to the flow-sampled packet.

9. The method of claim 8, further comprising:
maintaining the flow-sampled packet for each flow.

10. The method of claim 8, wherein the reference value corresponds to a value with respect to one of a number of flows maintained by the Internet network, a number of the packets included in the flows, and a size of the packet.

11. The method of claim 8, wherein the performing comprises correcting information about at least one of a sampling cycle count and a sampling random probability included in the packet, and performing the flow sampling with respect to the packet in response to the corrected information.

12. The method of claim 8, wherein the load information corresponds to information about at least one of a current number of flows in contrast to a maximum number of the flows to be maintained by the Internet network, and a number of the packets included in the flows.

13. The method of claim 8, further comprising:
receiving the reference value.

14. The method of claim 8, further comprising:
receiving sampling information about a scheme of performing the flow sampling,
wherein the performing comprises performing the flow sampling with respect to the packet in response to the sampling information.
